(19) United States
(12) Patent Application Publication
(10) Pub. No.: US 2006/0163367 A1
(43) Pub. Date: Jul. 27, 2006

(54) Smart card of a combination type providing with a stable contactless communication apparatus

(75) Inventors: Beak-Young Choi, Daegu-City (KR); Su-Ryong Byun, Daegu-City (KR)

Correspondence Address: NOTARO AND MICHALOS, 100 DUTCH HILL ROAD, SUITE 110, ORANGEBURG, NY, 10962-2100, US

(73) Assignee: BEAK-YOUNG CHOI AND SU-RYONG BYUM, DEAGU-CITY 702-012 (KR)

(21) Appl. No.: 10/526,950

(22) PCT Filed: Apr. 25, 2003
(86) PCT No.: PCT/KR03/00837

§ 371 Date: Mar. 8, 2005

(30) Foreign Application Priority Data
Oct. 31, 2002 (KR) 10-2002-0067011

(51) Int. Cl. G06K 19/06

(52) U.S. Cl. 235/492

(57) ABSTRACT

The present invention is to provide technology on a smart card of a combination type wherein the prior art milling process removed and a lamination process is used after connection between a chip on a COB and an antenna in order to improve physical reliability of a smart card of a combination type, thereby reducing the manufacturing cost of the smart card of a combination type and being capable of taking charge of an important role in introduction of a multiple-operation system of a smart card into a market and in market extension. The smart card according to the present invention comprises three or less lines in an antenna terminal portion as shown as reference numeral (2) in FIG. 6 so as to minimize an overlapped portion (A in FIG. 4a) between the antenna terminal portion and the COB for minimizing a value ^{c}mount.

### TECHNICAL FIELD

The present invention relates generally to a smart card of a combination type providing with a stable contactless communication apparatus, and more particularly to a smart card of a combination type which has an improved structure to remove the prior art milling process and to use a lamination process after connection between a chip on board (COB) and an antenna in order to improve physical reliability of a smart card of a combination type. Experimental results show that technology of a smart card of a combination type according to the present invention improves reliability of the conventional smart card of a combination type and reduces the manufacturing cost of the smart card of a combination type. The present invention is technology to newly improve the conventional structure and manufacturing processes of the smart card of a combination type, and at the same time, will take charge of an important role in introduction of a multiple-operation system of a smart card into a market and in market extension.

### BACKGROUND ART

In the conventional smart card of a combination type, trouble in contactless communication or radio frequency communication occurs during using of the card due to problems of its structure and manufacturing technology, thereby deteriorating the reliability of the smart card. Further, many badness factors are inherent in the manufacturing processes, being confronted with some problem such as increase of the manufacturing cost and the price of the smart card, etc.

The reasons of such problems can be found from the manufacturing technology using a milling process and an adhesive, as shown in FIG. 1 which is the process chart for manufacturing the conventional smart card of a combination type. Most poor qualities are caused by forming a recess for burying or implanting a COB by a milling process and disclosing an internal antenna by a precise adjustment process and that apparatus for such processes are high-priced. The COB is connected to the antenna using an electro-conductive adhesive and is fixed to the recess using a non-conductive adhesive, which causes the structure to be weak and their recovery to be difficult although poor quality of connection with the antenna is found during an RF communication test process. There is another problem that a surface of the card is damaged by the spontaneous use of intense heat and high voltage during implantation of the COB.

The smart card of a combination type manufactured according to the above manufacturing processes has the same sectional structure of the COB part as in FIG. 2. Further, contact portions between the COB and ends of the antenna have a structure as shown in an exploded perspective view of FIG. 3. That is, the COB, as shown in FIG. 3, is connected to opposite antenna terminals of a zigzag shape and forms a predetermined capacitance, which is called Cₘₒᵤₙₜ and calculated as in an equation (Eq.1) of FIG. 4a. Therefore, the equivalent circuit of the prior art smart card of a combination type is the same circuit that is shown in FIG. 4b and its resonance frequency is calculated as in an equation (Eq.2) of FIG. 4a.

It can be analyzed as a change in the resonance frequency why trouble in contactless communication or radio frequency communication occurs in the smart card of a combination type manufactured normally. Since the COB of FIG. 2 is fixedly mounted by a milling process and an adhesive, and therefore, a gap d between the COB and the antenna can increase if heat, humidity, deflection, etc., is added after the smart card is manufactured. If d increases, Cₘₒᵤₙₜ decreases and the resonance frequency fₒ increases more than in the conventional smart card, and thus it can be anticipated that trouble in contactless communication occurs. The other components of the equivalent circuit has no concern for being changed once the smart card of a combination type is manufactured. Also, the COB can be broken away from the smart card by severe external force.

### DISCLOSURE OF INVENTION

Accordingly, the present invention is made in order to solve the above problems, and one object of the present invention is to provide technology on a smart card of a combination type wherein physical reliability of a smart card of a combination type is improved. The proposed technology has an improved structure to remove the prior art milling process and to use a lamination process after connection between a chip on a COB and an antenna. Experimental results show that technology of a smart card of a combination type according to the present invention improves reliability of the conventional smart card of a combination type and reduces the manufacturing cost of the smart card of a combination type. Therefore, technology according to the present invention is to newly improve the conventional structure and manufacturing processes of the smart card of a combination type, and at same time, will take charge of an important role in introduction of a multiple-operation system of a smart card into a market and in market extension.

To accomplish the object of this invention, a smart card of a combination type provided with a stable contactless communication means is provided in accordance with one embodiment of the present invention, said smart card comprising three or less lines in an antenna terminal portion so as to minimize an overlapped portion between the antenna terminal portion and a chip on board (COB) for minimizing a capacitance value Cₘₒᵤₙₜ of the smart card of a combination type.

Furthermore, another embodiment of the present invention is to provide a smart card of a combination type which comprises a sheet layer provided with an antenna, at least one intermediate sheet layer and a printing sheet layer: wherein the card body and the COB are integrated as one body using a laminating process after the COB is connected with the antenna, and the antenna or the sheet layer provided with the antenna and said at least one intermediate sheet layer and/or the printing sheet layer are piled up prior to the laminating process, instead of the conventional method in which the COB is implanted, by means of a milling process, into an integrated card body of several sheet layers comprising the printing sheet layer using a laminating process.

### BRIEF DESCRIPTION OF DRAWINGS

FIG. 1 is a drawing showing processes for manufacturing the conventional smart card of a combination type.

FIG. 2 is a sectional view showing a part of a COB buried in the conventional smart card of a combination type.

FIG. 3 is an exploded perspective view showing contact portions between the COB and ends of an antenna in the conventional smart card of a combination type.

FIG. 4a is an equation for calculating a capacitance and a resonance frequency of appositive antenna terminals of a zigzag shape, and FIG. 4b is an equivalent circuit of the conventional smart card of a combination type.

FIG. 5a is a table showing a resonance frequency, a contactless communication distance and a displacement amount measured before and after a bending test, and FIG. 5b is a graph of impedance-frequency characteristics in the convention smart card of a combination type.

FIG. 6 is a schematic exploded perspective view showing contact portions between the COB and ends of an antenna in a smart card of a combination type according to one embodiment of the present invention.

FIG. 7 is a schematic plain view showing contact portions between the COB and ends of an antenna in a smart card of a combination type according to one embodiment of the present invention.

FIG. 8 is a sectional view showing a part of a COB buried in a smart card of a combination type according to one embodiment of the present invention.

FIG. 9 is a drawing showing processes for manufacturing a smart card of a combination type according to one embodiment of the present invention.

### BEST MODE FOR CARRYING OUT THE INVENTION

Now, a preferred embodiment of the present invention will be described in detail with reference to the accompanying drawings.

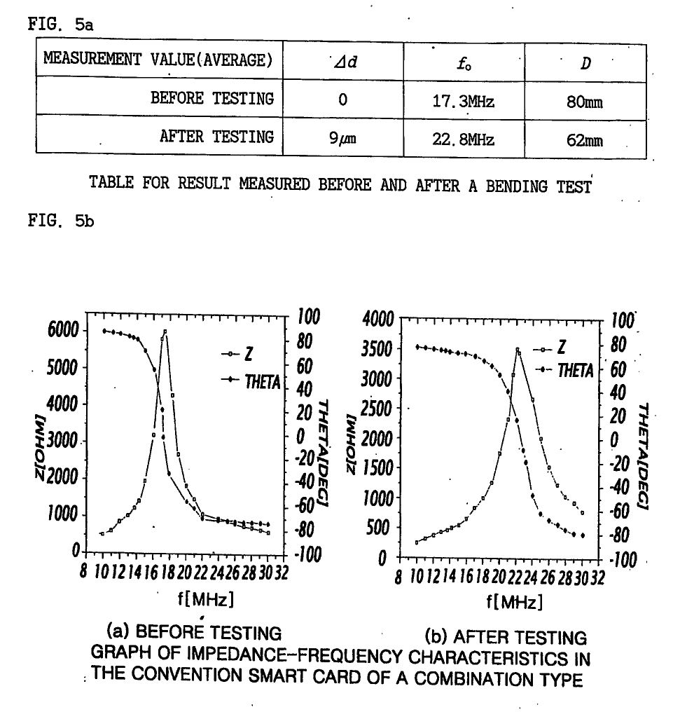

In order to confirm that a change in Cₘₒᵤₙₜ is one problem in contactless communication, a bending test is executed. In the test, a resonance frequency fₒ, a contactless communication distance D, and a displacement amount Δd of the COB from the surface of the smart card are measured as for a normally operated smart card of a combination type before and after the smart card is repeatedly bent 3000 times by 20 mm in up-and-down width in the longitudinal direction, which result is shown in FIGS. 5a and 5b. From the test result, the facts can be confirmed that the bending affects the structure of the COB, and in conclusion, affects the resonance frequency and the communication distance.

In order to overcome the problems of the conventional smart card of a combination type, the following improvements are required.

First, Cₘₒᵤₙₜ must be minimized.

Second, Cₘₒᵤₙₜ must not be changed even after time passes.

Third, a milling process must be removed.

Fourth, the COB can be easily recovered when poor quality of connection with the antenna is found during an RF communication test process.

Last, the manufacturing cost must be reduced.

In order to satisfy such requirements, the present invention is provided. Technology in the present invention removes the milling process in a method for manufacturing the convention smart card of a combination type and improves a structure of the COB and a connection method of the antenna, thereby presenting a newly improved structure of a smart card of a combination type and novel technology of manufacturing it.

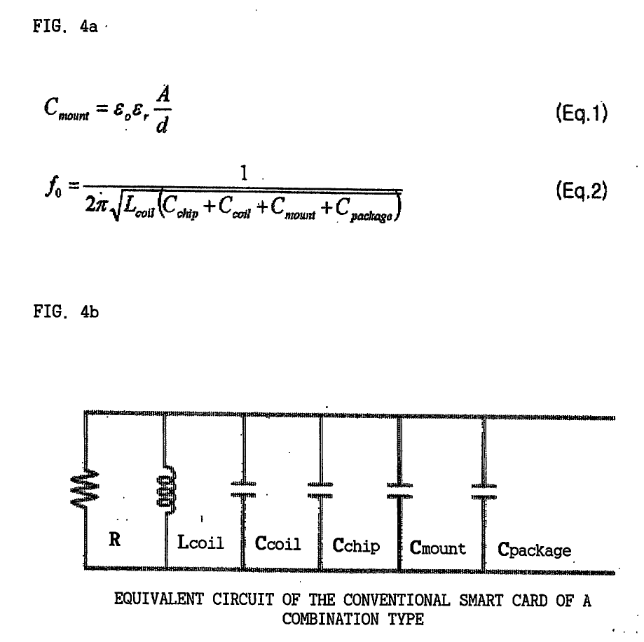

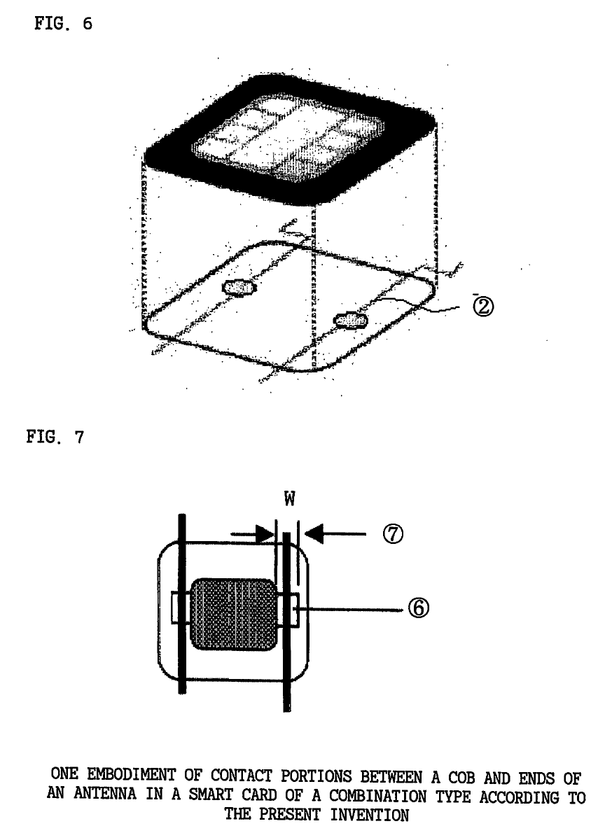

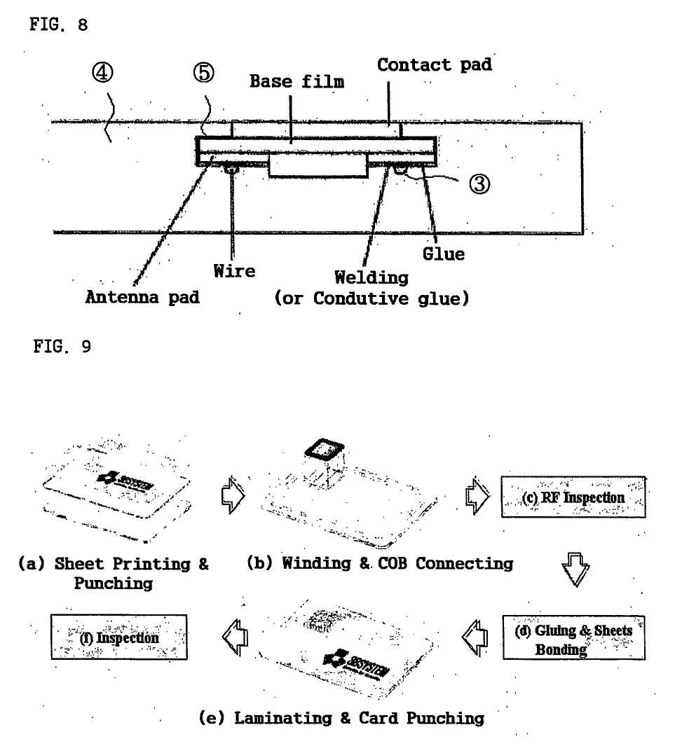

FIG. 8 shows a structure of a COB in the smart card of a combination type according to one embodiment of the present invention, and a method of connecting the antenna. The smart card according to the present invention comprises one to three lines in an antenna terminal portion of a zigzag shape so as to minimize an overlapped portion between the antenna terminal portion and the COB for minimizing a value Cₘₒᵤₙₜ differently from one in FIG. 3. In particular, reference numeral \textcircled{2} in FIG. 6 shows one embodiment according to the present invention. Thus, an area A in an equation (Eq.1) of FIG. 4a is minimized. Also, fixation of the value d is achieved by implanting a part of the COB structure into an interior of the card body \textcircled{4} in FIG. 8) and completely fixing a part \textcircled{5} to \textcircled{4} in FIG. 8 with an adhesive, as shown in FIG. 8. Therefore, reliability in contactless communication quality of a smart card of a combination type is guaranteed by the smart card of a combination type according to the present invention.

In this case, it is preferred that each of the antenna terminal portions has particularly one line so as to minimize each overlapped portion between each of the antenna terminal portions and the COB and is welded or soldered for electrical connection between the COB and each antenna terminal portion, as shown in FIG. 6 as reference numeral \textcircled{2}. Also, a width W, i.e., reference numeral \textcircled{7} in FIG. 7, of a connection pad of the COB in a direction alone which the coil of the antenna terminal portion passes is allowed to be 1.2 mm or less so that the overlapped portion between the antenna terminal portion and the COB, as shown in FIG. 7 as reference numeral \textcircled{6} (as reference numeral A in FIG. 3), is minimized. Further, it is possible to completely seal the COB in the card body with an adhesive provided between reference numerals \textcircled{4} and \textcircled{5} in FIG. 8. Preferably, a thickness of the COB itself satisfies 0.35˜0.55 mm in consideration for standards of smart cards of a combination type and stability of the COB.

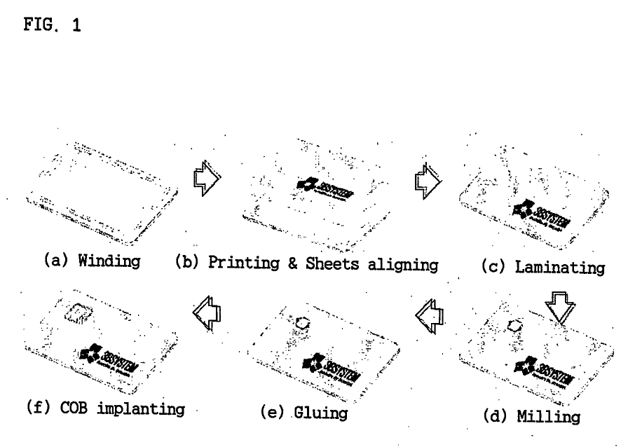

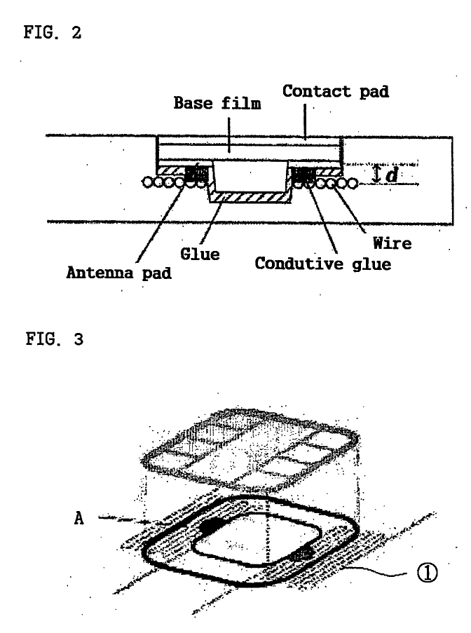

According to the conventional method of forming the conventional smart card of a combination type, a sheet layer provided with an antenna, at least one intermediate sheet layer and a printing sheet layer are integrated into one card body using a laminating process ((c) in FIG. 1), and then, the COB is implanted, by means of a milling process, into the integrated card body of several sheet layers comprising the printing sheet layer ((f) in FIG. 1). Instead, as in FIG. 9 for forming a smart card of a combination type according to another embodiment of the present invention, the COB is connected with the antenna, and the antenna or the sheet layer provided with the antenna and said at least one intermediate sheet layer and/or the printing sheet layer are piled up prior to the laminating process. Then, the card body and the COB are integrated as one body using a laminating process ((e) in FIG. 9). FIG. 9 shows concrete processes for manufacturing the smart card of a combination type. As in (a) of FIG. 9, a perforation for mounting the COB is formed by punching, etc., after printing is performed on said at least one intermediate sheet layer and the printing sheet layer. Then, an antenna is formed on one sheet of the intermediate sheet layer by winding, etc., and the COB is mounted and connected, as in (b) of FIG. 9. Subsequently, contactless communication test is performed as in (c) of FIG. 9, and an adhesive can be applied as in (d) of FIG. 9 if necessary, prior to mounting the COB. In (e) and (f) of FIG. 9, the laminating process and a final test are performed, thereby the manufacturing being completed. Although the embodiment is shown in FIG. 9, in which, after printing is performed on said at least one intermediate sheet layer and the printing sheet layer, a perforation for mounting the COB is formed by punching, etc., an antenna is formed on one sheet of the intermediate sheet layer by winding, etc., and then the COB is mounted and connected, the present invention comprises a case in which, prior to the laminating process, the COB is connected to the antenna, and the antenna of a coil or a film shape, or the sheet layer provided with the antenna and said at least one intermediate sheet layer and/or the printing sheet layer are piled up, and the present invention can comprise another sheet layer or an overlay layer, without limitation.

By virtue of the configuration and acting of the smart card of a combination type provided with a stable contactless communication means in accordance with the embodiments of the present invention described above, problems relating to a structure and reliability of the conventional smart card of a combination type can be improved fundamentally, and also, poor quality in the manufacturing processes and the manufacturing cost of the smart card of a combination type can be largely reduced.

1. A smart card of a combination type provided with a stable contactless communication means, said smart card comprising three or less lines of an antenna terminal portion so as to minimize an overlapped portion between the antenna terminal portion and a chip on board (COB) for minimizing a capacitance value Cₘₒᵤₙₜ of the smart card of a combination type.

2. The smart card of a combination type provided with a stable contactless communication means according to claim 1:
wherein the antenna terminal portion has particularly one line so as to minimize the overlapped portion between the antenna terminal portion and the COB, which is welded or soldered for electrical connection between the COB and the antenna terminal portion.

3. The smart card of a combination type provided with a stable contactless communication means according to claim 1:
wherein a width of a connection pad of the COB in a direction alone which the coil of the antenna terminal portion passes is 1.2 mm or less so that the overlapped portion between the antenna terminal portion and the COB is minimized.

4. A smart card of a combination type which comprises a sheet layer provided with an antenna, at least one intermediate sheet layer and a printing sheet layer:
wherein the card body and the COB are integrated as one body using a laminating process after the COB is connected with the antenna, and the antenna or the sheet layer provided with the antenna and said at least one intermediate sheet layer and/or the printing sheet layer are piled up prior to the laminating process, instead of the conventional method in which the COB is implanted, by means of a milling process, into an integrated card body of several sheet layers comprising the printing sheet layer using a laminating process.
